(19) United States
(12) Patent Application Publication
(10) Pub. No.: US 2005/0079383 A1
(43) Pub. Date: Apr. 14, 2005

(54) Organic light emitting medium containing 9, 9' -bianthry-10,10' -phenanthrcene and device containing the medium

(75) Inventors: Tung-Shen Lin, Tainan Hsien (TW); Wen-Chi Huang, Tainan Hsien (TW)

Correspondence Address: Cooper & Dunham LLP, 1185 Avenue of the Americas, New York, NY, 10036, US

(73) Assignee: Lightronik Technology Inc.

(21) Appl. No.: 10/685,120

(22) Filed: Oct. 14, 2003

(51) Int. Cl. H05B 33/14

(52) U.S. Cl. 428/690; 428/917; 428/212; 313/504; 313/506

(57) ABSTRACT

A phenylanthracene derivative, 9,9′-bianthry-10,10′-phenanthrcene, is used alone in an electroluminescent device and serves as a light emitting medium to emit white light.

### BACKGROUND OF THE INVENTION

1. Field of the Invention

The present invention relates to a phenylanthracene derivative of an organic light emitting medium, and more particularly to a 9,9′-bianthry-10,10′-phenanthrcene compound that emits white light and is used in an organic light emitting device.

2. Description of Related Art

Electroluminescent devices that utilize electroluminescence have high color contrast because of the self-emission features of the electroluminescent elements and excellent impact resistance because they are completely solid devices. Therefore, electroluminescent devices have attracted attention as light emitting sources in various types of display apparatus.

Phenylanthracene derivatives are important light emitting materials used in electroluminescenct devices and disclosed in many prior patents. In U.S. Pat. No. 5,635,308 ('308), the phenylanthracene derivatives are in the formula: A₁-L-A₂, wherein A₁ and A₂ are a monophenylanthryl or diphenylanthryl group and L is a valence bond or a divalent linkage group. Typically, the arylenes monophenylanthryl and diphenylanthryl are novel opto-electronic functional materials. In the '308 patent, the phenylanthracene derivatives are first deposited on the organic light emitting device and are defined broadly to mainly contain derivatives containing 10,10′-phenanthrcene structure (see the abstract and claim 1 of the '308 patent).

U.S. Pat. No. 6,534,199 ('199) narrowed the phenylanthracene derivative groups that emit blue light from the organic light emitting device. However, phenylanthracene derivatives emitting blue light are not widely popular since a device that can emit white light is a major objective of organic electroluminescent device development, because an organic electroluminescent device emitting white light can be used as the light source for single color displays and backlight module. Moreover, an organic device emitting white light can be used for full color display when color filters are attached to a display apparatus.

EP patent No. 1182244 ('244) disclosed a white organic electroluminescent element having a light emitting layer containing a light emitting material emitting blue light and a fluorescent compound (see the abstract and FIG. 1 of the '244 patent). Therefore, the light emitting material (i.e. the phenylanthracene derivative) has to mix with the fluorescent compound and cannot be used alone despite the fact that the organic electroluminescent element emits white light.

To overcome the shortcomings, the present invention provides a phenylanthracene derivative, 9,9′-bianthry-10,10′-phenanthrcene, applied on the organic electroluminescent element to mitigate or obviate the drawbacks of the conventional light emitting materials.

### SUMMARY OF THE INVENTION

The first objective of the invention is to provide a 9,9′-bianthry-10,10′-phenanthrcene compound of an organic light emitting medium that emits white light.

The second objective of the invention is to provide an electroluminescent device containing 9,9′-bianthry-10,10′-phenanthrcene served as an organic light emitting medium.

Other objectives, advantages and novel features of the invention will become more apparent from the following detailed description when taken in conjunction with the accompanying drawings.

### BRIEF DESCRIPTION OF THF DRAWINGS

FIG. 1 is an electroluminescence spectrum of example 1 of the organic electroluminescent device;

FIG. 2 is an electroluminescence spectrum of example 2 of the organic electroluminescent device;

FIG. 3 is an electroluminescence spectrum of example 3 of the organic electroluminescent device; and

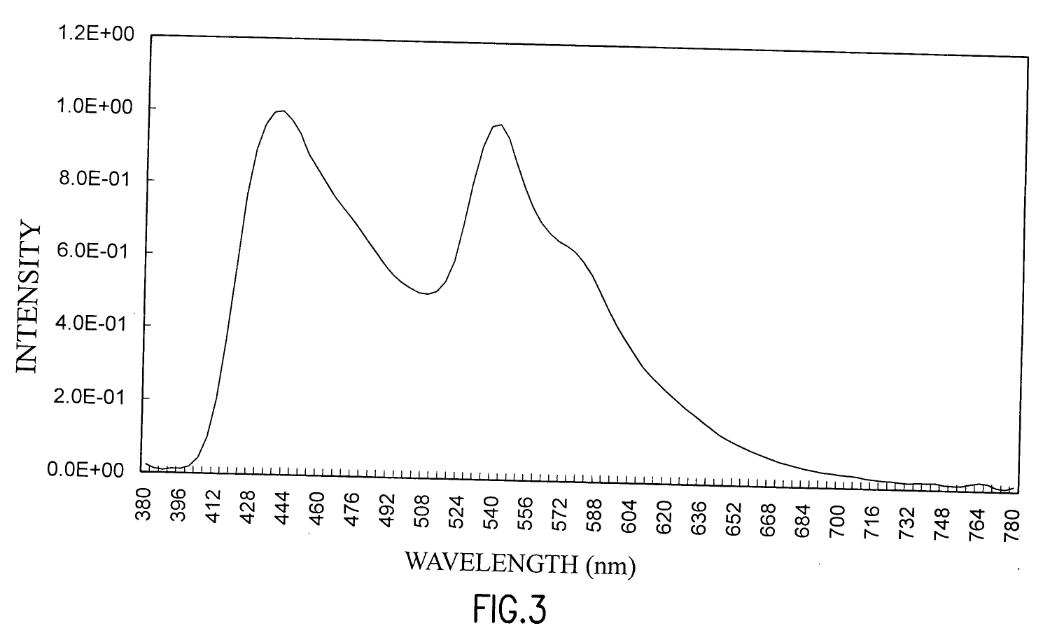

FIG. 4 is an electroluminescence spectrum of example 4 of the organic electroluminescent device.

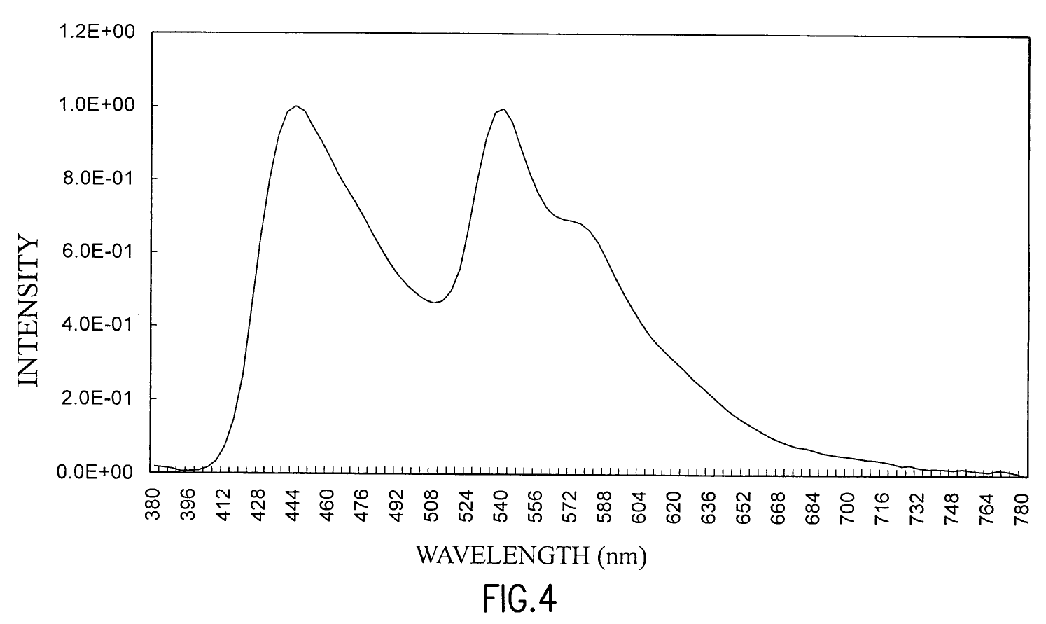

### DETAILED DESCRIPTION OF PREFERRED EMBODIMENT

A phenylanthracene derivative in accordance with the present invention is 9,9′-bianthry-10,10′-phenanthrcene and has the following chemical structure:

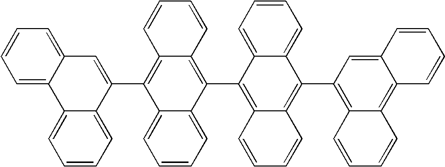

An organic electroluminescent device containing 9,9′-bianthry-10,10′-phenanthrcene compound is composed of an anode, a hole-transporting layer, at least one light emitting layer, an electron-transporting layer, an electron-injection layer and a cathode. The hole-transporting layer is laminated on the anode. The at least one light emitting layer is laminated on the hole transporting layer and contains 9,9′-bianthry-10,10′-phenanthrcene. The electron-transporting layer is formed on the at least one light emitting layer. The electron-injection layer is formed on the electron-transporting layer, and the cathode is formed on the electron-injection layer.

### Synthesis of 9,9′-bianthry-10,10′-phenanthrcene

5 g of 10,10′-dibromo-9,9′-bianthracene, 8.67 g of 9-phenanthrylboronic acid, 3.4 g of potassium fluoride, 46 ml of palladium acetate, 58 mg of o-(biphenyl)P(t-Bu)2, 20 ml of tetradrofuran were sequentially placed into reacting bottle to become a mixture and thermally refluxed for 20 hours. Then, the mixture was cooled down to room temperature and filtered to obtain impure solid. Lastly, the impure solid was further sublimated to obtained 0.4 g of 9,9′-bianthry-10,10′-phenanthrcene, wherein the melting point of 9,9′-bianthry-10,10′-phenanthrcene is 558° C.

Examples of several embodiments of the organic electroluminescent device following:

### EXAMPLE 1

An organic electroluminescent device has a glass substrate with an (ITO) (indium-tin-oxide) electrode with a surface resistance of 20 ohm as an anode. A 60 nm organic layer was laminated on the anode by vacuum deposition of NPB (N,N′-di(1-naphthyl)-N,N′-diphenyl-[1,1′-biphenyl]-4,4′-diamine) to serve as a hole-transporting layer. A 40 nm emitting layer was formed on the hole transporting layer by vacuum deposition of 9,9′-bianthry-10,10′-phenanthrcene. Then a 20 nm electron-transporting layer was formed on the emitting layer by vacuum deposition of Alq3 (aluminum tris(8-hydroxyquinolate)), wherein the Alq3 has the following chemical structure:

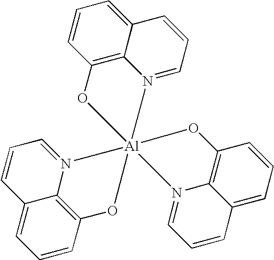

Additionally, a 0.8 nm electron-injection layer was deposited on the electron-transporting layer by vacuum deposition of LiF. Lastly, a 200 nm aluminum cathode was formed on the electron-injection layer to achieve the organic electroluminescent device.

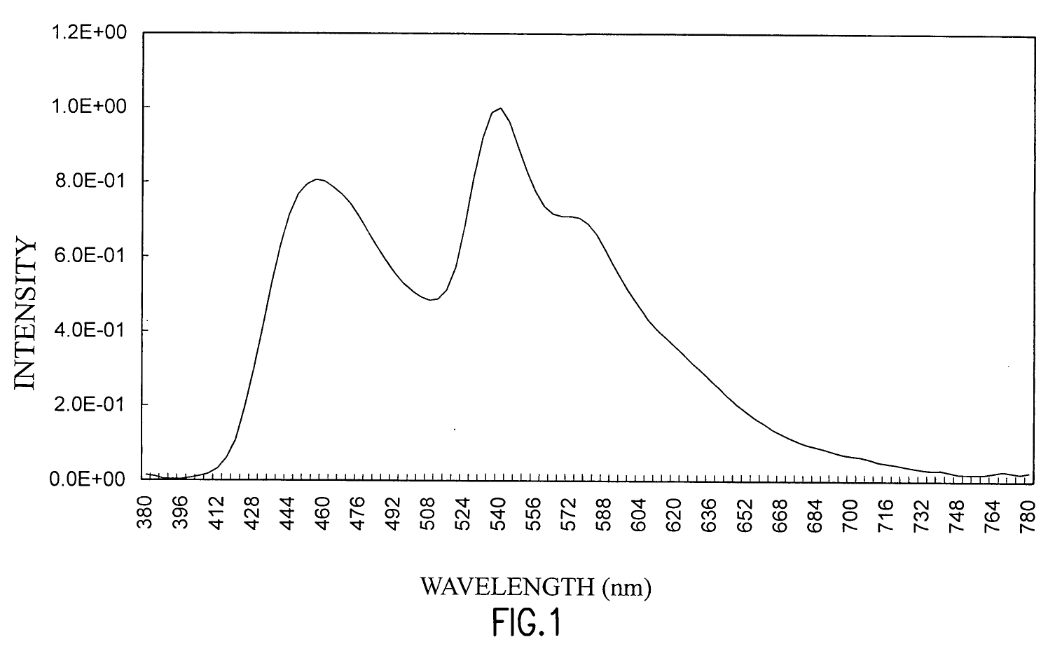

When a direct current (DC) voltage was applied to the achieved organic electroluminescence device, a yellowish white light emission with CIE coordinate value (0.3, 0.36) was obtained. With reference to FIG. 1, the electroluminescent spectrum of the light emitted from the electroluminescent device was recorded.

### EXAMPLE 2

An organic electroluminescent device was formed with the same ITO anode and aluminum cathode as the electroluminescent device in example 1.

A 60 nm hole-injection layer was formed on the ITO electrode by vacuum deposition of HIM(A), wherein HIM(A) has the following chemical structure:

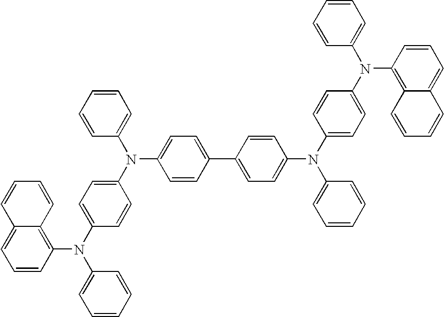

A 30 nm hole-transporting layer was laminated on the hole injection layer by vacuum deposition of NPB. Then, a 20 nm emitting layer was deposited on the hole-transporting layer by a vacuum deposition of 9,9′-bianthry-10,10′-phenanthrcene. A 20 nm electron-transporting layer was laminated on the emitting layer by vacuum deposition of Alq3. On the electron-transporting layer, a 0.8 nm electron-injection layer was formed by vacuum deposition of LiF. Lastly, a 200 nm aluminum cathode was formed by vacuum deposition on the electron-injection layer. The resultant product was an organic electroluminescent device.

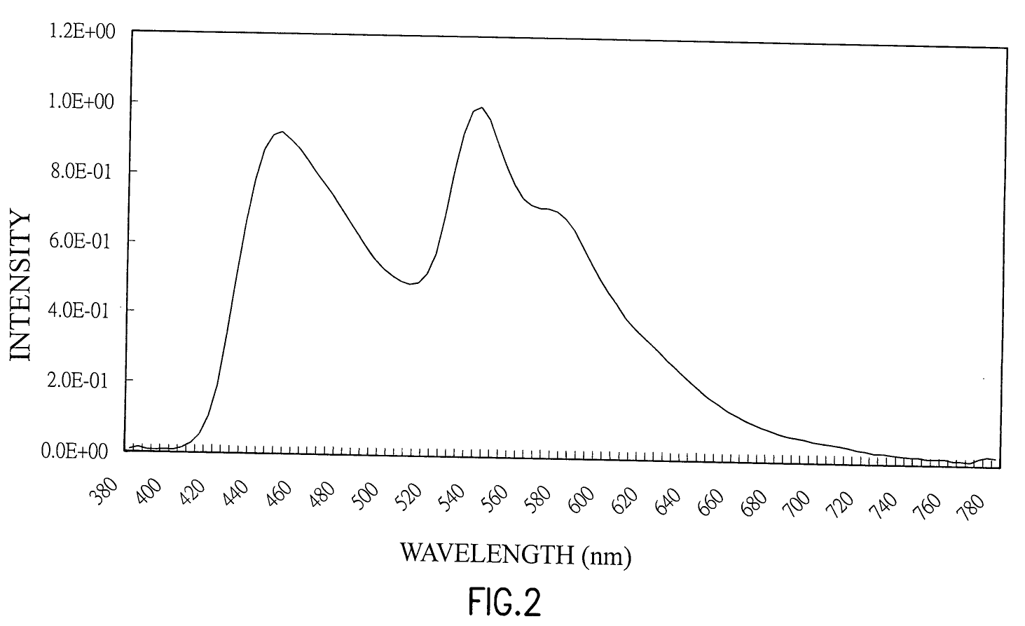

When a direct current (DC) voltage was applied to the organic electroluminescent device, a yellowish white light emission with CIE 1931 coordinate value (0.29, 0.34) was obtained. With reference to FIG. 2, the electroluminescent spectrum of the light emitted from the electroluminescent device was recorded.

### EXAMPLE 3

An organic electroluminescent device was formed with the same ITO anode and aluminum cathode as the organic electroluminescent device in example 1.

A 80 nm hole-injection layer was formed on the ITO electrode by vacuum deposition of HIM(A). A 20 nm first emitting layer was formed by vacuum co-deposition of NPB and blue dopant (A), wherein the NPB is a host material and the blue dopant (A) having the following chemical structure is added to the NPB in a concentration of 5% to 10%.

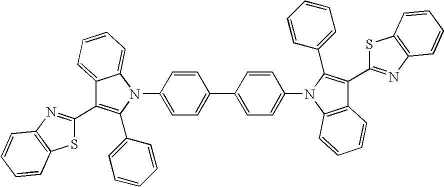

Then, a 30 nm second emitting layer was deposited on the first emitting layer by vacuum deposition of 9,9′-bianthry-10,10′-phenanthrcene. A 10 nm electron-transporting layer was formed on the second emitting layer by vacuum deposition of Alq3. A 0.8 nm electron-injection layer was deposited on the electron-transporting layer by vacuum deposition of LiF. Lastly, a 200 nm aluminum cathode was formed by vacuum deposition on the electron-injection layer. The resultant product was an organic electroluminescent device.

When a direct current (DC) voltage was applied to the organic electroluminescent device, a white light emission with CIE 1931 coordinate value (0.26, 0.32) was obtained.

### EXAMPLE 4

An organic electroluminescent device was formed with the same ITO anode and aluminum cathode as the organic electroluminescent device in example 1.

A 80 nm hole-transportating layer was formed on the ITO electrode by vacuum deposition of NPB (N,N′-di(1-naphthyl)-N,N′-diphenyl-[1,1′-biphenyl]-4,4′-diamine). A 10 nm first emitting layer was formed by vacuum deposition of emitter compound (A) that has the following chemical structure.

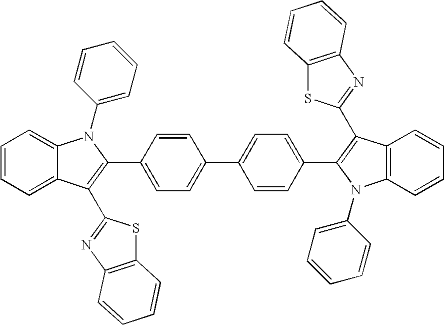

Then, a 30 nm second emitting layer was deposited on the first emitting layer by vacuum deposition of 9,9′-bianthry-10,10′-phenanthrcene. A 10 nm electron-transporting layer was formed on the second emitting layer by vacuum deposition of Alq3. A 0.8 nm electron-injection layer was deposited on the 1 electron-transporting layer by vacuum deposition of LiF. Lastly, a 200 nm aluminum cathode was formed by vacuum deposition on the electron-injection layer. The resultant product was an organic electroluminescent device.

When a direct current (DC) voltage was applied to the achieved organic electroluminescent device, a white light emission with CIE 1931 coordinate value (0.29, 0.33) was obtained.

Based on the foregoing embodiments of organic electroluminescence devices, a phenylanthracene derivative, i.e. 9,9′-bianthry-10,10′-phenanthrcene, can be used alone in a emitting layer to permit the organic electroluminescent device to emit white light.

Even though numerous characteristics and advantages of the present invention have been set forth in the foregoing description, together with details of the function of the invention, the disclosure is illustrative only, and changes may be made in detail, especially in matters of shape, size, and arrangement of parts within the principles of the invention to the full extent indicated by the broad general meaning of the terms in wich the appended claims are expressed.

1. An organic electroluminescent device comprising:
an anode;
a hole-transporting layer laminated on the anode;
at least one light emitting layer laminated on the hole transporting layer, wherein the at least one light emitting layer contains 9,9′-bianthry-10,10-phenanthrcene;
an electron-transporting layer formed on the at least one light emitting layer;
an electron-injection layer formed on the electron-transporting layer; and
a cathode formed on the electron-injection.

2. The organic electroluminescent device as claimed in claim 1, wherein the organic electroluminescent device has two light emitting layers, one of the light emitting layers contains 9,9′-bianthry-10,10′-phenanthrcene to emit white light and the other light emitting layer emits blue light.

3. The organic electroluminescent device as claimed in claim 2, wherein the blue light emitting layer contains both hole-transporting material and blue light emitting material.

4. The organic electroluminescent device as claimed in claim 2, wherein the blue light emitting layer contains at least one blue light emitting material.

5. An organic light emitting medium adapted to apply on an organic electroluminescent device, wherein the organic light emitting medium contains 9,9′-bianthry-10,10′-phenanthrcene.
